(19) United States
(12) Patent Application Publication
(10) Pub. No.: US 2005/0160899 A1
(43) Pub. Date: Jul. 28, 2005

(54) Adjustable removable accessory arm for a drum

(76) Inventor: Ronn J. Dunnett, Delta (CA)

Correspondence Address: Mr. Ronn J. Dunnett, 4587 57th Street, Delta, BC, V4K 3E4, CA

(21) Appl. No.: 11/027,069

(22) Filed: Dec. 30, 2004

Related U.S. Application Data
(60) Provisional application No. 60/533,547, filed on Dec. 31, 2003.

(51) Int. Cl. G10D 13/02

(52) U.S. Cl. 84/421

(57) ABSTRACT

An accessory arm for providing a connection between a percussion instrument having a laterally disposed socket and an accessory is described. The accessory arm includes a plug for engaging the socket and a coupler, supported by the plug, for engagement with the accessory.

### CROSS REFERENCE TO RELATED APPLICATIONS

This application claims priority from U.S. Provisional Patent Application Ser. No. 60/533,547 filed on Dec. 31, 2003, entitled “Adjustable Removable Accessory Arm for a Drum”, which is expressly incorporated by reference herein.

### BACKGROUND OF THE INVENTION

1. Field of the Invention

The present invention relates to drum kits, and more particularly to the hardware for assembling percussion instruments together into a kit.

2. Description of Related Art

Frequently, drummers may want to convert a horizontally-oriented drum, for example a floor tom-tom, mounted tom-tom or hand drum, such as a djembe or conga, which are traditionally played with the playing surface at or near a horizontal angle, into a vertically-oriented drum, for example a bass drum, which is traditionally played with the playing surface at or near a vertical angle. Typically, this reconfiguration is done as a convenient means of conserving space, either for travel, shipping or set-up of a drum kit or for the purpose of achieving a different type of sound.

So reconfigured, the drum can also become the foundation of a drum kit, upon which may be mounted a variety of accessories, including other drums and percussive instruments, for example cymbals and cowbells.

Typically, such accessories have been mounted to a vertically-oriented drum, for example a bass drum, on a fixture, commonly called a consolette or rail mount.

Conventionally, this fixture is permanently attached to the drum by bolts, screws or other means, and so disadvantageously the amount of adjustability for any accessory mounted to the fixture is limited.

The conventional, permanent rail mount arrangements suffer from other disadvantages as well. Adding holes, screws or bolts to a drum may change its musical properties. What is needed is an adjustable, removable accessory arm for a drum, that does not require dedicated holes or hardware for attachment to the drum.

### SUMMARY OF THE INVENTION

The present invention is directed to this need.

Broadly, the invention takes advantage of the fact that a horizontally-oriented drum, for example a tom, typically has at least three lateral sockets disposed about its perimeter to engage legs for support. When such a drum is reconfigured to present a substantially vertical playing surface, only the two lowermost of those sockets are required to engage legs for support. Any remaining socket, for example the uppermost socket, is thus free to adjustably engage a removable accessory arm, with requiring any additional holes, screws or bolts into the drum.

Therefore, according to one aspect of the present invention, there is provided an apparatus for providing a connection between a percussion instrument having a laterally disposed socket and an accessory, the apparatus having a plug for engaging the socket and a coupler, supported by the plug, for engagement with the accessory.

The coupler might include an elongated lug for clamping the accessory to and the lug might be oriented transversely to the plug and adjacent the percussion instrument, in which case the lug and the percussion instrument would define a slot between them. The apparatus might further include a foot for supporting the coupler against the percussion instrument, the foot being connected to the coupler remote from the plug. The foot might include a damper for damping vibration between the coupler and the instrument. The damper might also include a frictional surface abutting the percussion instrument.

The plug might have an elongated body, such that it is able to engage the socket at more than one location along its elongated body. The plug might also be able to engage the socket from either of two directions.

According to another aspect of the invention, there is provided an apparatus for providing a connection between a percussion instrument having a laterally disposed socket and an accessory, the apparatus having means for engaging the socket and means for coupling the accessory, supported by the plug.

The accessory-coupling means might include means for clamping the accessory to, which might be oriented transversely to socket-engaging means and adjacent the percussion instrument, in which case the clamping means and the percussion instrument would define a slot between them.

The apparatus might further include means for supporting the accessory-coupling means against the percussion instrument, the supporting means perhaps being connected to the accessory-coupling means remote from the socket-engaging means.

The supporting means might include a means for damping vibration between the accessory-coupling means and the percussion instrument. The damping means might also include a frictional surface abutting the percussion instrument.

The socket-engaging means might have an elongated body, in which event the socket-engaging means might engage the socket at more than one location along its elongated body or might engage the socket from either of two directions.

Further aspects and advantages of the present invention will become apparent upon considering the following drawings, description, and claims.

### DESCRIPTION OF THE INVENTION

The invention will be more fully illustrated by the following detailed description of non-limiting specific embodiments in conjunction with the accompanying drawing figures.

In the figures, similar components and/or features may have the same reference label. Further, various components of the same type may be distinguished by following the reference label with a second label that distinguishes among the similar components. If only the first reference label is identified in a particular passage of the detailed description, then that passage describes any one of the similar components having the same first reference label irrespective of the second reference label.

### BRIEF DESCRIPTION OF THE DRAWINGS

FIG. 1 is a rear-side elevational view of an accessory arm according to one embodiment of the present invention.

FIG. 2 is a front-side elevational view of the accessory arm of FIG. 1, removably mounted to a drum.

FIG. 3 is a side elevational view of the accessory arm of FIG. 1, removably mounted to the drum.

FIG. 4 is a front elevational view of the accessory arm of FIG. 1, removably mounted to the drum.

### DETAILED DESCRIPTION OF SPECIFIC EMBODIMENTS

(a) Structure

The structure of the invention will now be illustrated by way of explanation of a non-limiting specific exemplary embodiment shown in the drawing figures and described in greater detail herein.

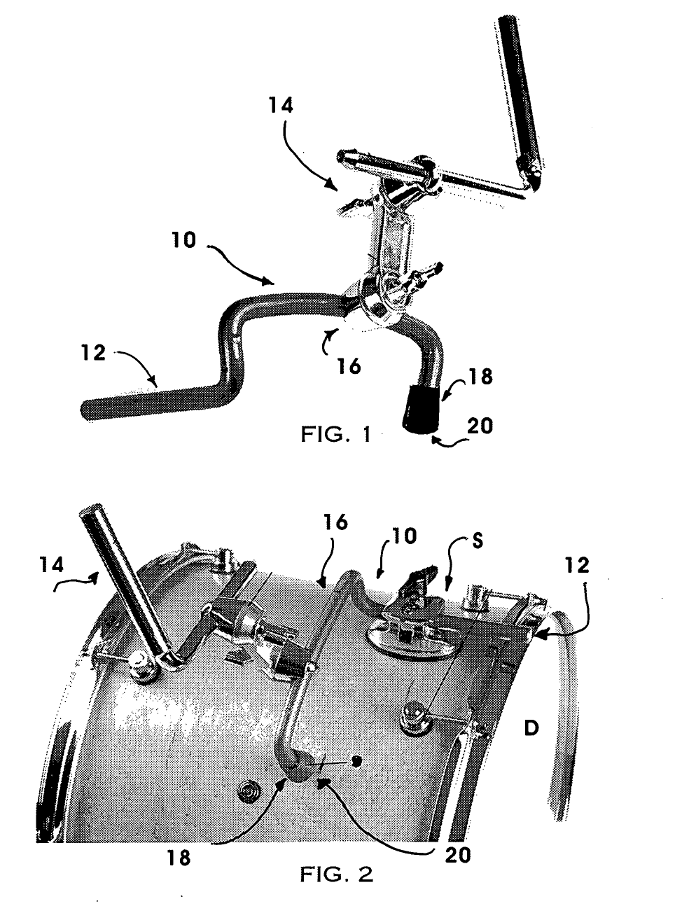

FIG. 1 shows an accessory arm according to one embodiment of the present invention, generally illustrated at 10. The accessory arm 10 includes a plug 12 and a coupler, generally illustrated at 14, supported by the plug 12. The coupler 14 includes a lug 16 for clamping to, and may also include various predetermined clamps and extensions extending from the lug 16 and adapted to engage specific accessories, for example those clamps and extensions illustrated in FIG. 1. The accessory arm 10 may also include a foot 18, which may include a damper 20 having a frictional exterior surface, desirably non-abrasive.

The accessory arm 10 may be formed as a single body or from distinct parts. All or portions of the accessory arm 10 may be solid or hollow.

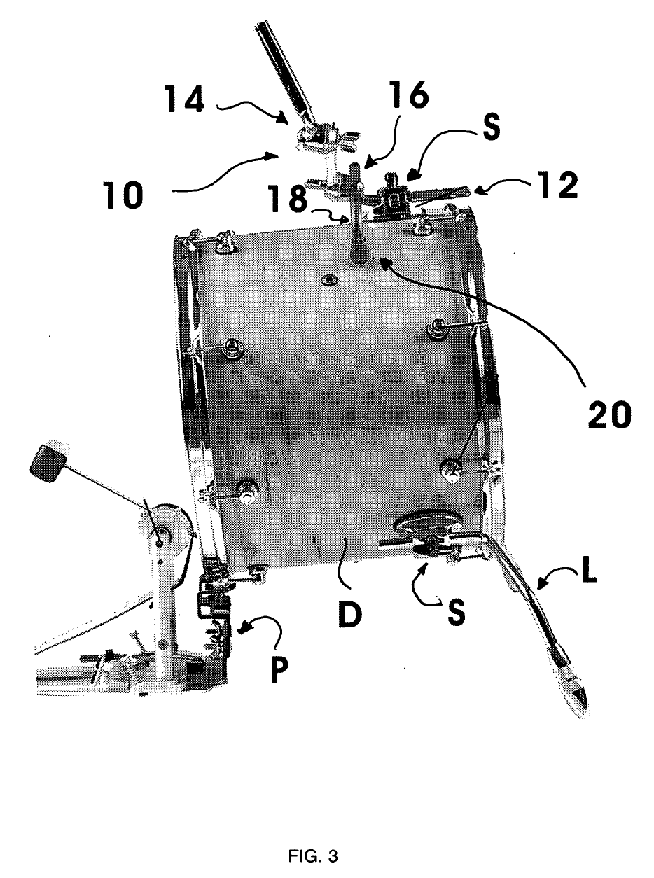

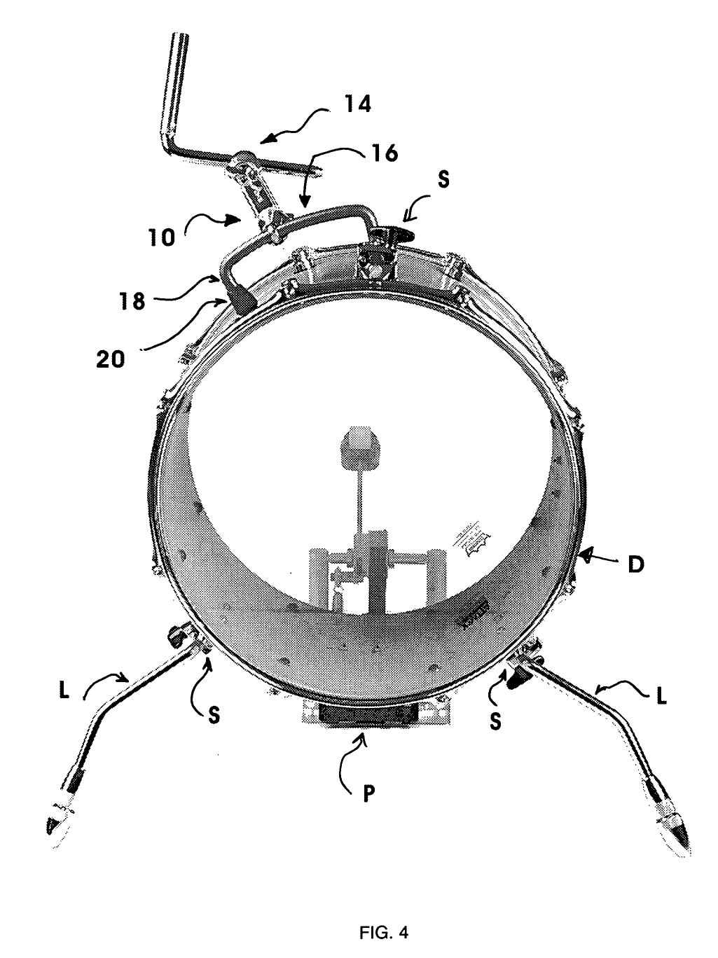

FIGS. 2 through 4 show a vertically-oriented drum D supported by two legs L and a pedal P, each of the two legs L being respectively engaged within one of two laterally disposed sockets S on a bottom portion of the perimeter of the drum D.

The drum D also includes a third laterally disposed socket S on a top portion of the perimeter of the drum D, that would more conventionally be used to engage a third drum leg (not shown) when the drum D was configured in a horizontal orientation. As shown in FIGS. 2 through 4, this free third socket S engages the accessory arm 10 at its plug 12, securing the accessory arm 10 to the drum D perimeter.

Desirably, the plug 12 has an elongated body that can engage the socket S at more than one location along its length, so that the accessory arm 10 can be positioned at more than one position between the two rims of the drum D. Desirably, the plug 12 can be rotated within the socket S so that the accessory arm 10 can be positioned at various angles to the drum D perimeter. Desirably, the plug 12 can be inserted into the socket S from either direction so that the accessory arm 10 can be respectively positioned to either the right side or left side of the socket S.

The lug 16 may be oriented transversely to the plug 12 and adjacently to the drum D. Desirably, the lug 16 and the drum D are separated by a slot so as not to obstruct other mounting hardware, for example a clamp

In the event that the accessory arm 10 includes a foot 18, the foot 18 would also urge against the perimeter of the drum D, providing additional support for the coupler 14. Such support is particularly robust in embodiments with the foot 18 located on the accessory arm 10 remote from the plug 12, for example separated from the plug 12 by the coupler 14.

In the event that the foot 18 included a damper 20, the damper 20 would provide some vibrational isolation between the coupler 14 and the drum D. The frictional, but desirably non-abrasive, exterior surface of the damper 20 would help to resist movement of the foot 18 relative to the drum D.

(b) Operation

With reference now to FIGS. 1 through 4, the operation of this specific embodiment of the invention will now be described.

When a user wishes to mount accessories on the drum D in its vertical orientation, he inserts the plug 12 of the accessory arm 10 into a free socket S on the perimeter of the drum D and retains the plug 12 therewithin, for example by tightening a screw assembly in the socket S. Where the socket S is of the through-hole variety, the user might insert the plug 12 into either end of the socket S. For further adjustment, the user might slide the plug 12 a greater or lesser distance into the socket S. For still further adjustment, the user might rotate the plug 12 within the socket S and, in the event that the accessory arm 10 also includes a foot 18, the user might rotate the plug 12 within the socket S until the foot abuts the perimeter of the drum D. With the accessory arm 10 so secured to the drum D, the coupler 14, and in particular the lug 16, is disposed for engaging accessories, the lug 16 and the drum D creating a slot between them so as not to obstruct other mounting hardware.

When the user wishes to remove the accessories and perhaps reconfigure the drum D into its horizontal orientation, he need only remove the accessory arm 10 by disengaging the plug 12 from the socket S.

(c) Description Summary

Thus, it will be seen from the foregoing embodiments and examples that there has been described a way to provide a connection between a percussion instrument having a laterally disposed socket and an accessory.

While a specific embodiment of the invention has been described and illustrated, this embodiment should be considered illustrative of the invention only and not as limiting the invention as construed in accordance with the accompanying claims.

It will be understood by those skilled in the art that various changes, modifications and substitutions can be made to the foregoing embodiments without departing from the principle and scope of the invention expressed in the claims made herein.

1. An apparatus for providing a connection between a percussion instrument having a laterally disposed socket and an accessory, the apparatus comprising:
a) a plug for engaging the socket; and
b) a coupler, supported by said plug, for engagement with the accessory.

2. An apparatus as claimed in claim 1, wherein said coupler includes an elongated lug for clamping the accessory to.

3. An apparatus as claimed in claim 2, wherein said lug is oriented transversely to said plug.

4. An apparatus as claimed in claim 3, wherein said lug is oriented adjacent the percussion instrument.

5. An apparatus as claimed in claim 4, wherein said lug and the percussion instrument define a slot therebetween.

6. An apparatus as claimed in claim 5, further comprising a foot for supporting said coupler against the percussion instrument.

7. An apparatus as claimed in claim 6, wherein said foot is connected to said coupler remote from said plug.

8. An apparatus as claimed in claim 7, wherein said foot includes a damper for damping vibration between said coupler and the percussion instrument.

9. An apparatus as claimed in claim 8, wherein said damper includes a frictional surface abutting the percussion instrument.

10. An apparatus as claimed in claim 9, wherein said plug has an elongated body.

11. An apparatus as claimed in claim 10, wherein said plug is operable to engage the socket at more than one location along its elongated body.

12. An apparatus as claimed in claim 12, wherein said plug is operable to engage the socket from either of two directions.

13. An apparatus for providing a connection between a percussion instrument having a laterally disposed socket and an accessory, the apparatus comprising:
a) means for engaging the socket; and
b) means for coupling the accessory, supported by said plug.

14. An apparatus as claimed in claim 13, wherein said accessory-coupling means includes means for clamping the accessory to.

15. An apparatus as claimed in claim 14, wherein said clamping means is oriented transversely to socket-engaging means.

16. An apparatus as claimed in claim 15, wherein said clamping means is oriented adjacent the percussion instrument.

17. An apparatus as claimed in claim 16, wherein said clamping means and the percussion instrument define a slot therebetween.

18. An apparatus as claimed in claim 17, further comprising means for supporting said accessory-coupling means against the percussion instrument.

19. An apparatus as claimed in claim 18, wherein said supporting means is connected to said accessory-coupling means remote from said socket-engaging means.

20. An apparatus as claimed in claim 19, wherein said supporting means includes a means for damping vibration between said accessory-coupling means and the percussion instrument.

21. An apparatus as claimed in claim 20, wherein said damping means includes a frictional surface abutting the percussion instrument.

22. An apparatus as claimed in claim 21, wherein said socket-engaging means has an elongated body.

23. An apparatus as claimed in claim 22, wherein said socket-engaging means is operable to engage the socket at more than one location along its elongated body.

24. An apparatus as claimed in claim 23, wherein said socket-engaging means is operable to engage the socket from either of two directions.
